(19) United States
(12) Patent Application Publication
(10) Pub. No.: US 2010/0220498 A1
(43) Pub. Date: Sep. 2, 2010

(54) SURFACE LIGHT SOURCE DEVICE AND PRISM SHEET

(76) Inventors: Yasuhiko Awano, Tokyo (JP); Tokutaro Komatsu, Chiba (JP); Masato Taya, Ibaraki (JP); Yasushi Sugimoto, Ibaraki (JP); Tadashi Okuda, Ibaraki (JP); Teruo Teshima, Tochigi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/997,570

(22) PCT Filed: May 15, 2006
(86) PCT No.: PCT/JP2006/309638

§ 371 Date: May 14, 2010

(30) Foreign Application Priority Data
Aug. 3, 2005 (JP) 2005-225324
Dec. 16, 2005 (JP) 2005-363197

(51) Int. Cl. F21V 7/04

(52) U.S. Cl. 362/611; 362/620

(57) ABSTRACT

A surface light source device is disclosed that provides greater light condensation in the frontal direction and higher luminance in comparison to a conventional surface light source device. Disclosed is a surface light source device providing a light source, a light guide having at least one of the side surfaces thereof as an incident surface and an outgoing surface substantially perpendicular to the incident surface, and at least two prism sheets, in which the surfaces formed by the prisms of the prism sheets are arranged so as to face upward, moreover the surfaces of the sides opposing the surfaces formed by the prisms of the prism sheets are arranged substantially parallel to the outgoing surface of the light guide. Further, in this surface light source device the prisms are arranged so as to be substantially parallel to the incident surface of the light guide, the half width of emitted light distribution of the light guide is not greater than 30°, and within a cross-section of the prism of the first prism sheet substantially perpendicular to both the outgoing surface and the incident surface of the light guide, the angle θF₁ formed between the oblique side of the light source side and the normal to the outgoing surface of the light guide satisfies expression (1), the angle θB₁ between the oblique side of the opposite side to the light source and the normal to the outgoing surface of the light source satisfies expression (2), while within a cross-section of the prism of the i-th prism sheet (where i is an integer not less than 2) arranged on the outgoing surface of the first prism sheet substantially perpendicular to both the outgoing surface and the incident surface of the light guide, the angle θFᵢ between the oblique side of the light source side and the normal to the outgoing surface of the light guide satisfies expression (3) and the angle θBᵢ between the oblique side of the opposite side to the light source and the normal to the outgoing surface of the light source satisfies expression (4), wherein

θF₁≦φ₂ (1),

90°−φ₂−φ_{c1}≦θB₁ (2),

θFᵢ≦φ₆ (3)

and

90°−φ₆−φ_{ci}≦θBᵢ (4),

where in expression (1), φ₂=sin¹ (n₁⁻¹ sin φ₁), n₁ is the refractive index of the material of which the prism of the first prism sheet is formed, φ₁ represents the angle formed between the peak light of light emitted from the light guide and the normal to the outgoing surface of the light guide, in expression (2), φ_{c1} represents the critical angle of the first prism sheet, in expression (3), φ₆=sin⁻¹ (nᵢ⁻¹ sin φ₅), nᵢ is the refractive index of the material of which the prism of the i-th prism sheet is formed, φ₅ represents the angle between the peak light of light emitted from the i−1 prism sheets and the normal to the outgoing surface of the light guide, and in expression 4, φ_{ci} represents the critical angle of the i-th prism sheet.

### TECHNICAL FIELD

The present invention relates to a surface light source device used for a liquid crystal display device or the like and a prism sheet used in the surface light source device.

### BACKGROUND ART

A liquid crystal display device operates to display an image by injecting light from a backlight disposed on the rear surface of a liquid crystal panel. The backlight is the component in a liquid crystal display device that consumes the most power and therefore has a significant impact on the length of time which the drive battery of a portable device such as a mobile phone or mobile game machine or the like can be used. In order to enable the drive battery of such a mobile device to be used for a long time, without diminishing the brightness of the backlight, this power consumption must be reduced as much as possible. That is to say, a way must be found that enables the light from a light source in a backlight to be admitted, as much as possible, in a frontal direction.

Here, FIG. 1 shows an example of a backlight 1 of the side edge type having the light source arranged on a side edge, used mainly for portable devices. Light emitted from the light source 4 passes via a light guide input part 5 and enters the light guide 3. This light that enters the light guide 3 is emitted therefrom in a diagonal direction, then the direction of this light is changed to a frontal direction by a prism sheet 2 arranged over the light guide 3, before it is emitted from this prism sheet 2. It is this prism sheet 2 (the first prism sheet) that is of crucial importance in enabling light from the light source 4 of this type of backlight device 1 to be emitted in a frontal direction.

Various different configurations have been proposed for the prism sheet (first prism sheet) 2, depending mainly on whether the prism surface has an upward or downward inclination. Examples of the type having a prism surface of an upward inclination include Japanese Patent Application Laid-open No. 8-160204, Japanese Patent Application Laid-open No. 7-201217, and International Publication WO 96/10148 pamphlet, while examples of the type having a prism surface of a downward inclination include Japanese Patent Application Laid-open No. 8-262441, Japanese Patent Application Laid-open No. 8-271705 and Japanese Patent Application Laid-open No. 11-084111.

What is most important for the prism sheet (first prism sheet) 2 being able to effectively change the direction of the light to a frontal direction is the size of the apex angle of the prism. In the above cited documents, there is discussion of the scope for setting this prism apex angle and of the method for calculation. Japanese Patent Application Laid-open No. 8-160204 is the document however, that covers determining the conditions for the apex angle of the prism requiring fulfillment, from the relationship between the inclination of the inclined surface of the prism, and the traveling direction of light rays inside the prism and in the vicinity of the prism. A brief explanation of this will now be provided with reference to FIG. 2.

FIG. 2 provides a cross-sectional view of the prism of the first prism sheet 2 disposed opposing the outgoing surface side of the light guide 3, so as to be substantially parallel to the light guide. The peak light 12a which is the light emitted from the light guide 3 enters the first prism sheet 2 at the angle φ₁ to the normal 9 of the output surface of the light guide 3. At this time the angle θF₁ between the normal 9 of the output surface of the light guide 3 and the oblique side of the light source side fulfills expression (5)

0°≦θF₁≦φ₂+10° (5)

In expression (5), φ₂=sin⁻¹ (n⁻¹ sin φ₁), where n is the refractive index of the material of which the prism is made.

According to expression (5), the phenomenon can be prevented in which peak light emitted from the light guide undergoes total reflection at the oblique side 10a of the light source side and is emitted as dispersed light 14 from the oblique side 11a opposite to the light source side, in a direction that is not frontal direction.

Japanese Patent Application Laid-open No. 8-160204 discloses that when the angle formed between peak light 13a, of the light emitted from the oblique side on the side opposite to the light source of the first prism sheet and the normal to the outgoing surface of the light guide is 0°, that is to say, within the range ±10° centered around the value of θB₁ when peak light is emitted in the frontal direction, the value of θB₁ can be determined. Thus, peak light emitted from the light guide undergoes total reflection at the oblique side 11a opposing the light source side and is prevented from traveling completely away from the frontal direction.

The above example envisages that only a first prism sheet is used as the determination of the conditions for the apex angle of the prism is made. That is to say, in the case in which the peak light of the light emitted from the first prism sheet enters a second prism sheet and also enters a prism sheet arranged above that, the conditions for determining the apex angles of these prism sheets are not given.

The object of the present invention is to provide a surface light source device that produces greater luminance in comparison to conventional surface light source devices and that enables light to be strongly condensed in the frontal direction and a prism sheet used in this surface light source device.

### DISCLOSURE OF THE INVENTION

In order to solve the above described problems, the surface light source device according to the present invention provides a light source, a light guide having at least one of the side surfaces thereof as an incident surface and an outgoing surface substantially perpendicular to the incident surface, and a prism sheet, in which the surface on the side opposing the surface formed by the prism of the prism sheet is arranged so as to be substantially parallel to the outgoing surface of the light guide, moreover, the prism is arranged so as to be substantially parallel to the incident surface of the light guide, within a cross-section of the prism of the prism sheet substantially perpendicular to both the outgoing surface and the incident surface of the light guide, the angle θF₁ formed between the oblique side of the light source side and the normal to the outgoing surface of the light guide satisfies expression (1), while the angle θB₁ formed between the oblique side on the opposite side to the light source and the normal to the outgoing surface of the light guide satisfies expression (2).

θF₁≦φ₂ (1)

In expression (1) φ₂=sin⁻¹ (n₁⁻¹ sin φ₁), where n₁ is the refractive index of the material of which the prism of the prism sheet is formed, and φ₁ represents the angle formed between the peak light of the light emitted from the light guide and the normal to the outgoing surface of the light guide.

90°−φ₂−φ_{c1}≦θB₁ (2)

In expression (2) φ_{c1}=sin⁻¹ (n₁⁻¹) represents the critical angle of the prism sheet.

It is preferable that the angle θF₁ fulfills expression (1a) and that the angle θB₁ satisfies expression (2a).

θF₁≦φ₂−δ₁ (1a)

In expression (1a), δ₁ shows the value of half of the half width of the light emitted from the light guide.

90°−φ₂−φ_{c1}+δ₂≦θB₁ (2a)

In expression (2a), δ₂ shows the value of half of the half width of the light refracted in the prism sheet so that peak light of the light emitted from the light guide enters the prism sheet at an angle φ₁ to the normal of the outgoing surface of the light guide and in the same way peak light of light emitted from the angle formed with the normal to the outgoing surface of the light guide is refracted in the prism sheet at the angle φ₂ to the normal of the outgoing surface of the light guide.

The prism sheet comprises a transparent optical sheet and a plurality of prisms disposed on one surface of the optical sheet in which the prisms having a constant shape are disposed in parallel with uniform pitch. The prisms are described as “in parallel” when the longitudinal edges of the prisms are disposed in parallel.

It is preferable that the angle θF₁ satisfies expression (1b), and that the angle θB₁ satisfies the expression (2b).

θF₁≦φ₂−δ₁×2 (1b)

90°−φ₂−φ_{c1}+δ₂×2≦θB₁ (2b)

It is preferable that inside the above cross-section, the half width of the emitted light distribution from the light guide is not greater than 30°.

It is preferable that inside the above cross-section, the half width of the emitted light distribution from the light guide is not less than 15° and not greater than 30°.

It is preferable that inside the above cross-section, the peak outgoing angle of emitted light distribution of the light guide is not less than 60°.

It is preferable that the prism pitch is not less than 30 μm.

The prism sheet related to the present invention is used for the above described surface light source device.

Further, the surface light source device related to the present invention provides a light source, a light guide having at least one of the side surfaces thereof as an incident surface and an outgoing surface substantially perpendicular to the incident surface, and at least two prism sheets, in which the surfaces formed by the prisms of the prism sheets are arranged at the same orientation, moreover the surfaces of the sides opposing the surfaces formed by the prisms of the prism sheets are arranged substantially parallel to the outgoing surface of the light guide, moreover, the prisms are arranged so as to be substantially parallel to the incident surface of the light guide, within a cross-section of the prism of the first prism sheet substantially perpendicular to both the outgoing surface and the incident surface of the light guide, the angle θF₁ formed between the oblique side of the light source side and the normal to the outgoing surface of the light guide satisfies expression (1), the angle θB₁ between the oblique side of the opposite side to the light source and the normal to the outgoing surface of the light source satisfies expression (2), within a cross-section of the prism of the i-th prism sheet (where i is an integer not less than 2) arranged on the outgoing surface of the first prism sheet substantially perpendicular to both the outgoing surface and the incident surface of the light guide, the angle θFᵢ between the oblique side of the light source side and the normal to the outgoing surface of the light guide satisfies expression (3) and the angle θBᵢ between the oblique side of the opposite side to the light source and the normal to the outgoing surface of the light source satisfies expression (4).

θF₁≦φ₂ (1)

In (1), φ₂=sin⁻¹ (n₁⁻¹ sin φ₁). Here, n₁ is the refractive index of the material of which the prism of the first prism sheet is formed, φ₁=sin⁻¹ (n₁⁻¹) shows the angle formed between the peak light of light emitted from the light guide and the normal to the outgoing surface of the light guide.

90°−φ₂−φ_{c1}≦θB₁ (2)

In expression (2), φ_{c1} shows the critical angle of the first prism sheet.

θFᵢ≦φ₆ (3)

In expression (3), φ₆=sin⁻¹ (nᵢ⁻¹ sin φ₅). Here, nᵢ is the refractive index of the material of which the prism of the i-th prism sheet is formed, and φ₅ is the angle formed between the normal to the outgoing surface of the light guide and the peak light of light emitted from the i−1 prism sheets.

90°−φ₆−φ_{ci}≦θBᵢ (4)

In expression 4, φ_{ci}=sin⁻¹ (nᵢ⁻¹) shows the critical angle of the i-th prism sheets.

It is preferable that the angles θF₁, θB₁, θFᵢ and θBᵢ fulfill the following expressions (1a), (2a), (3a) and (4a).

θF₁≦φ₂−δ (1a)

In expression (1a), δ₁ represents the value of half the half width of light emitted from the light guide.

90°−φ₂−φ_{c1}+δ₂≦θB₁ (2a)

In expression (2a) δ₂ shows the value of half of the half width of the light refracted in the prism sheet so that peak light of the light emitted from the light guide enters the prism sheet at an angle φ₁ to the normal of the outgoing surface of the light guide and in the same way peak light of light emitted from the angle formed with the normal to the outgoing surface of the light guide is refracted in the prism sheet at the angle φ₂ to the normal of the outgoing surface of the light guide.

θFᵢ≦φ₆−δ₃ (3a)

In expression (3a), δ₃ shows the value of half the half width of light emitted from the i−1 prism sheets.

90°−φ₆−φ_{ci}+δ₄≦θBᵢ (4a)

In expression (4a), δ₄ shows that peak light of light emitted from the i−1st prism sheets is input to the i-th prism sheet at the angle φ₅ to the normal of the outgoing surface of the light guide, and in the same way, shows the value of half of the half width of the light refracted at the angle φ₆ to the normal of the outgoing surface of the light guide.

It is preferable that the angles θF₁, θB₁, θFᵢ and θBᵢ fulfill the following expressions (1b), (2b), (3b) and (4b).

θF₁≦φ₂−δ₁×2 (1b)

90°−φ₂−φ_{c1}+δ₂×≦θB₁ (2b)

θFᵢ≦φ₆−δ₃×2 (3b)

90°−φ₆−φ_{ci}+δ₄×≦θBᵢ (4b)

It is preferable that inside the above cross-section, the half width of the emitted light distribution of the light guide be not greater than 30°.

It is preferable that inside the above cross-section, the half width of the emitted light distribution of the light guide be not less than 15° and not greater than 30°.

It is preferable inside that cross-section, that the angle of emittance at which emitted light distribution of the light guide peaks is not less than 60°.

It is preferable that the pitch of the prism be not less than 30 μm.

The prism sheet according to the present invention is the i-th prism sheet used for the above described surface light guide device.

In comparison to conventional surface light source devices, the surface light source device according to the present invention provides greater luminance and enables light to be strongly condensed in the frontal direction, as well as a prism sheet used in this surface light source device.

### BRIEF DESCRIPTION OF THE DRAWINGS

FIG. 1 shows an example of a backlight of the type in which the light source is arranged on a side edge;

FIG. 2 is a cross-sectional drawing of the first prism sheet;

FIG. 3 shows an example of the surface light source device according to the present invention;

FIG. 4 (a) is a cross-sectional drawing of the prism of the second or the i-th prism sheet of a surface light source device according to the present invention and FIG. 4 (b) is a cross-sectional drawing of the prism of the first prism sheet of a surface light source device according to the present invention;

FIG. 5 shows the characteristics of light emittance of light guide 1 used in embodiment 1 of the surface light source device according to the present invention;

FIG. 6 shows the results of luminance measurements for embodiment 1 of the surface light source device according to the present invention and comparative example 1;

FIG. 7 shows the characteristics of light emittance of light guide 2 used in embodiment 2 of the surface light source device according to the present invention;

FIG. 8 shows the results of luminance measurements for embodiment 2 of the surface light source device according to the present invention and comparative example 1;

FIG. 9 shows the light emittance characteristics of light guide 3 used for embodiment 3 and embodiment 4 of the surface light source device according to the present invention;

FIG. 10 shows the results of luminance measurements for embodiment 3 of the surface light source device according to the present invention and comparative example 1;

FIG. 11 shows the results of luminance measurements for embodiment 4 of the surface light source device according to the present invention and comparative example 1;

FIG. 12 shows the light emittance characteristics of light guide 4 used for embodiment 5 of the light source device according to the present invention and comparative example 1, comparative example 2 and comparative example 3;

FIG. 13 shows the results of luminance measurements for embodiment 5 of the surface light source device according to the present invention and comparative example 1; and

FIG. 14 shows the luminance measurements for embodiment 5 of the surface light source device according to the present invention and comparative example 1, comparative example 2 and comparative example 3.

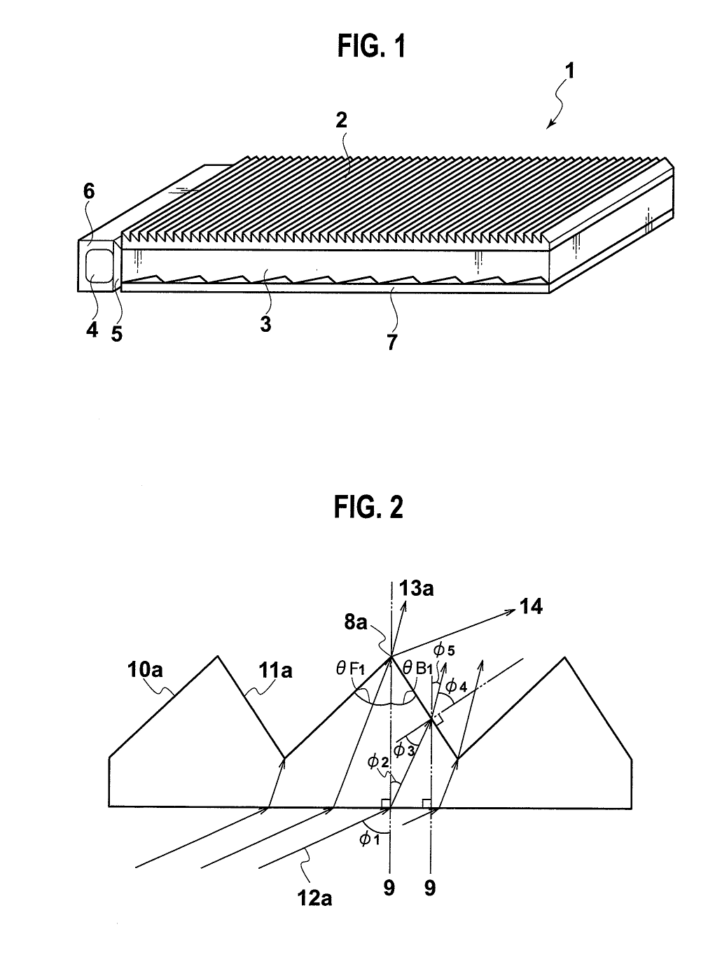

### BEST MODE FOR CARRYING OUT THE INVENTION

The embodiments of the present invention will now be described in detail with reference to the drawings.

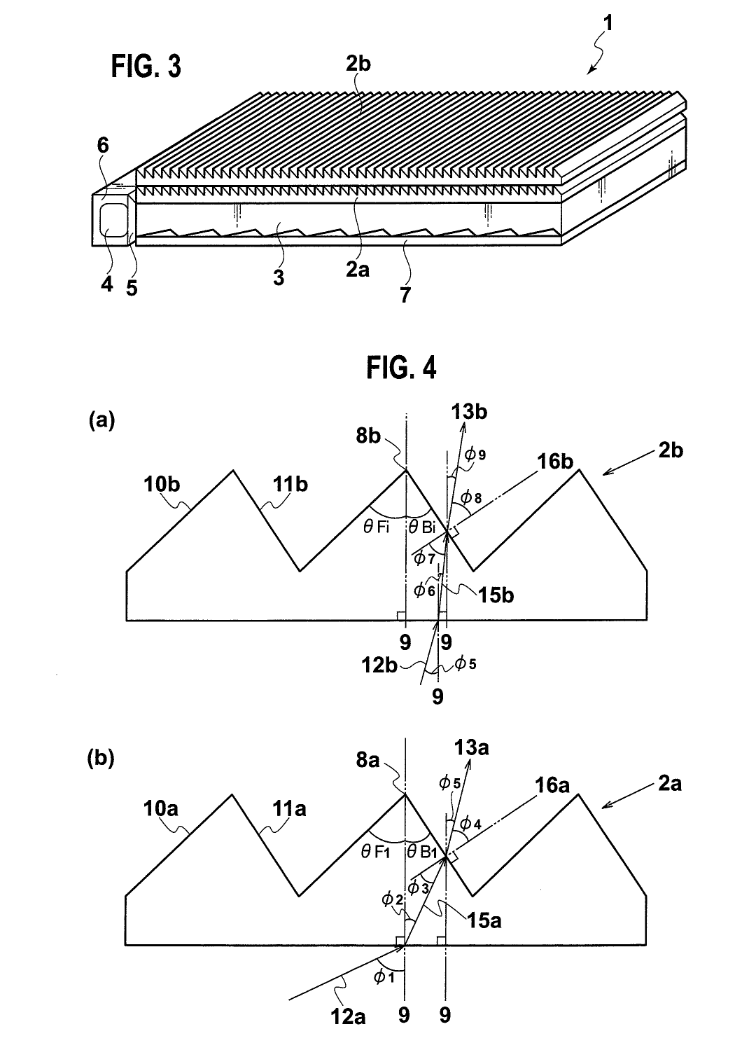

As shown in FIG. 3, in a surface light source device 1 providing a light source 4, a light guide 3 at least one of the side surfaces of which is an incident surface and having an outgoing surface that is substantially perpendicular to the incident surface, and at least two prism sheets 2a and 2b, the form of the prisms of the at least two prism sheets 2a and 2b is optimized so as to efficiently change the inclination of light that is emitted from the light source 4, passes the light guide 3 and injected into the first prism sheet 2a, such that there is an increase in the proportion of that light that is emitted in the frontal direction of the front light source device 1. An explanation will now be provided using FIG. 4 of the optical paths of light in the at least two prism sheets 2a and 2b of the surface light source device and the method for determining the form of the prisms of the prism sheets in order to achieve that. FIG. 4 shows the form of the prisms of the at least to prism sheets 2a and 2b inside a cross-section substantially perpendicular to both the incident surface and the outgoing surface of the light guide 3. In reality the phenomena of refraction and total reflection in a prism occur at the inclined surfaces of the prism, however here, to facilitate discussion of the issue of the angles, the inclined surfaces of the prism are indicated as oblique sides in FIG. 4 and the cross-section is illustrated in FIG. 4 as a straight line.

As shown in FIG. 4 (b), peak light 12a emitted from the light guide 3 enters the first prism sheet 2a at the angle ch to the normal 9 of the outgoing surface of the light guide 3, and in the same way, becomes the peak light 15a of the light refracted at the angle φ₂ to the normal 9 of the outgoing surface of the light guide 3. Here, φ₂ is obtained from expression (6).

sin φ₁=n₁ sin φ₂ (6)

Here, n₁ is the refractive index of the material of which the prism of the first prism sheet is formed. This refracted peak light 15a is refracted at the oblique side 11a of the side opposite the light source of the prism of the first prism sheet and emitted from the first prism sheet. At this time, if the refracted light, peak light 15a is input to the oblique side 10a of the light source side of the prism of the first prism sheet the light will undergo total reflection and be dispersed, until finally it is not output in the frontal direction of the surface light source device 1, meaning there is a substantial possibility of significant light loss. In order to avoid this, the angle θF₁ between the oblique side 10a and the normal 9 to the outgoing surface of the light guide 3 must satisfy expression (1).

θF₁≦φ₂ (1)

If refracted light, peak light 15a forms the angle φ₃ with the straight-line 16a perpendicular to the oblique side 11a when entering the oblique side 11a, in the same manner, peak light 15a forms the angle φ₄ with the straight-line 16a perpendicular to the oblique side 11a, and is output becoming emitted light, peak light 13a. φ₄ is obtained from expression (7).

n₁ sin φ₃=sin φ₄ (7)

At this time, there is concern that if the refracted light, peak light 15a undergoes total reflection at oblique side 11a it will eventually be dispersed in directions making it difficult to be output in the frontal direction of the surface light source device 1. In order to prevent the occurrence of total reflection of this refracted light, peak light 15a at the oblique side 11a the angle θB₁ between the oblique side 11a and the normal 9 to the outgoing surface of the light guide 3 must satisfy expression (2).

90°−φ₂−φ_{c1}≦θB₁ (2)

Here, φ_{c1} shows the critical angle of the first prism sheet. As described, θF₁ and θB₁ of the prism of the first prism sheet can be determined by expression (1) and expression (2).

The method for determining the form of the prism of the i-th prism sheet will now be described. Here, i represents an integer not less than 2. FIG. 3 shows the surface light source device having two prism sheets arranged. Based on this, in FIG. 4, a cross-section of two prism sheets is shown, but as this corresponds to the case when i is two, FIG. 4 is used as it is for the following explanation also in which the symbol used is the i-th prism sheet.

As shown in FIG. 4 (a), peak light 12b emitted from the i−1 prism sheet enters the i-th prism sheet 2b at the angle φ₅ to the normal 9 of the outgoing surface of the light guide 3, and in the same way, becomes peak light 15b of light refracted at the angle φ₆ to the normal 9 of the outgoing surface of the light guide 3. Here, φ₅ is obtained from expression (8) and φ₆ is obtained from the expression (9).

φ₉=90°−φ₄−θB₁ (8)

sin φ₅=nᵢ sin φ₆ (9)

Here, n₁ is the refractive index of the material of which the prism of the i-th prism sheet is formed. The peak light 15b of this refracted light is refracted at the oblique side 11b on the side opposite to the light source of the prism of the i-th prism sheet and emitted from the i-th prism sheet. At this time, if the refracted light, peak light 15a is input to the oblique side 10b of the light source side of the prism of the i-th prism sheet the light will undergo total reflection and be dispersed, until finally it is not output in the frontal direction of the surface light source device 1, meaning there is a substantial possibility of significant light loss. In order to avoid this, the angle θF₁ between the oblique side 10b and the normal 9 to the outgoing surface of the light guide 3 must satisfy expression (3).

θFᵢ≦φ₆ (3)

If refracted light, peak light 15b forms the angle φ₇ with the straight-line 16b perpendicular to the oblique side 11b when entering the oblique side 11b, in the same manner, peak light 15b forms the angle φ₈ with the straight-line 16b perpendicular to the oblique side 11b, and is output becoming emitted light, peak light 13b. φ₈ is obtained from expression (10).

nᵢ sin φ₇=sin φ₈ (10)

At this time, there is concern that if the refracted light, peak light 15b undergoes total reflection at oblique side 11b it will eventually be dispersed in directions making it difficult to be output in the frontal direction of the surface light source device 1. In order to prevent the occurrence of total reflection of this refracted light, peak light 15b at the oblique side 11b the angle θBᵢ between the oblique side 11b and the normal 9 to the outgoing surface of the light guide 3 must satisfy expression (4).

90°−φ₆−φ_{ci}≦θBᵢ (4)

Here, φ_{ci} shows the critical angle of the i-th prism sheet. When the angle between the peak light 13b of the light emitted by refraction at oblique side 11b and the normal 9 to the outgoing surface of the light guide 3 is made φ₉, φ₉ is obtained from the expression (11).

φ₉=90°−φ₈−θBᵢ (11)

As described, θFᵢ and θBᵢ of the prism of the first prism sheet can be determined by expression (3) and expression (4).

Light emitted from the light guide 3 or light emitted from the i−1 prism sheet 2a actually has a distribution in emittance angles. Taking this into consideration, θF₁, θB₁, θF and θBᵢ should satisfy the expressions (1a), (2a), (3a) and (4a).

θF₁≦φ₂−δ₁ (1a)

90°−φ₂−φ_{c1}+δ₂≦θB₁ (2a)

θFᵢ≦φ₆−δ₃ (3a)

90°−φ₆−φ_{c1}+δ₄≦θB₁ (4a)

Here, δ₁ shows the value of half of the half width of light emitted from the light guide 3. δ₂ shows that peak light of light emitted from the light guide 3 enters the first prism sheet 2a at the angle φ₁ to the normal 9 of the outgoing surface of the light guide 3, and in the same way, shows the value of half of the half width of light refracted at the angle φ₂ to the normal 9 of the outgoing surface of the light guide 3. δ₃ shows the value of half of the half width of light emitted from the i−1 prism sheets, and δ₄ shows that peak light 12b of light emitted from the i−1 prism sheets enters the i-th prism sheet 2b at the angle φ₅ to the normal 9 of the outgoing surface of the light guide 3, and in the same way, shows the value of half of the half width of light refracted at the angle φ₆ to the normal 9 of the outgoing surface of the light guide 3.

Further, as it occurs that half of the half width of light emitted from the light guide 3 spreads completely, it is preferable that θF₁, θB₁, θFᵢ and θBᵢ satisfy the expressions (1b), (2b), (3b and (4b), respectively.

θF₁≦θ₂−δ₁×2 (1b)

90°−φ₂−φ_{c1}+δ₂×2≦θB₁ (2b)

θFᵢ≦φ₆−δ₃×2 (3b)

90°−φ₆−φ_{ci}+δ₄×2≦θBᵢ (4b)

In order to satisfy the relationships as described above, the half width of emitted light distribution from the light guide 3 must be not less than 30°. This enables the range of θF₁, θB₁, θFᵢ and θBᵢ that satisfy the relations of the expressions (1a), (2a), (3a) and (4a), or, the expressions (1b), (2b), (3b) and (4b) to be ascertained.

It is preferable in the surface light source device 1 according to the present invention, that the half width of emitted light distribution of the light guide 3 be not less than 15° and not greater than 30°. The reason that it is preferable that this half width of emitted light distribution of the light guide 3 be not less than 15° is that this brings a degree of spread to the distribution of emission angles of light emitted from the light guide 3, thereby maintaining a proportion of light that can be used. If the half width of emitted light distribution of the light guide 3 were less than 15°, regardless of how efficiently the inclination of light were changed at the at least two prism sheets 2a and 2b, the proportion of light that could be used would be small from the beginning, thus it would eventually become impossible to maintain the required proportion of light that must be output in the frontal direction of the light guide 1.

It is preferable in the surface light source device 1 according to the present invention, that the peak angle of emittance of emitted light distribution of the light guide 3 be not less than 60°. This is because if the value of the angle φ₁ between peak light of light emitted from the light guide 3 and the normal 9 to the outgoing surface of the light guide 3 is not less than 60°, at the first prism sheet, the refracted light bringing the light 15a to peak light can easily be made to reach the oblique side 11a. If the value of the angle φ₁ between the light of light emitted from the light guide 3 and the normal 9 to the outgoing surface of the light guide 3 is less than 60°, at the first prism sheet, the refracted light bringing the light 15a to peak light would not be able to reach the oblique side 10a, which would result in total reflection occurring at the oblique side 10a and finally, there would be a high possibility that the light would not be emitted in the frontal direction of the surface light source device 1.

It is preferable in the surface light source device 1 according to the present invention, that the prism pitch be not less than 30 μm. This is because in the surface light source device 1 having arranged therein at least two prism sheets 2a and 2b, the light emitted from the light guide 3 is directed in the frontal direction of the surface light source device 1 by being efficiently refracted, without causing light dispersion due to diffraction, at the at least two prism sheets 2a and 2b. If the prism pitch is less than 30 μm, light dispersion due to diffraction occurs, and it becomes difficult to emit the light in the frontal direction of the surface light source device 1 in a condition in which the wavelength spectrum of the emitted light from the light guide 3 is maintained.

The at least two prism sheets 2a and 2b of the present invention may be formed as a single body, and it is suitable to choose a substrate film and apply thereon a material for forming the shape of the prism. The materials that can be used when using this single body configuration include polyester resin, acrylic resin, polycarbonate resin, polyvinyl chloride resin, polymethacrylimide resin, polyethylene resin, polypropylene resin, ethylene-vinyl acetate resin, polystyrene resin, or ring-opening metathesis polymer hydride of norbornene monomer. The materials that can be used for the substrate film include for example polyester resin, acrylic resin, polycarbonate resin, polyvinyl chloride resin or polymethacrylimide resin. As the material used for forming the prism form over the substrate film it is preferable to use an ultraviolet cured resin, and preferably an ultraviolet cured resin that is an acrylic having superior light transmission properties. Examples of resins that are acrylic resins, ultraviolet cured, include urethane acrylate and epoxy acrylate.

As a method for producing the prism form it is possible to use a method of directly drawing using an electron beam or laser light for example, however this method is not suitable for mass production, so in practice, the method employed involves transference from an original. The methods for producing the original include a machine processing method using a tool bit, applying an electron beam resist over the substrate then etching with reactive ion etching (RIE) after drawing with the electron beam, a method involving exposure and development using x-ray light irradiation, or exposure and development of a gray scale mask pattern.

The method of transference of a prism form from the original to the material used for forming the prism can involve an extrusion forming method, injection molding, thermal transference or a UV light transference method.

The light guide 3 provides a mechanism for changing the inclination of light input from the input surface, which mechanism is disposed on the surface on the reflective sheet side of the light guide 3, such that light the inclination of which is so altered continually undergoes total reflection inside the light guide 3 as it is output as light of a specific directivity having a peak of a specific direction. The mechanism disposed on the surface of the reflective sheet side of the light guide 3 for changing the inclination of the light can be realized by a method of providing reflective dots or by providing depressions known as reflective grooves. The reflective dots method involves applying, either by screen printing or what is known as the injection method, a reflective ink formed by kneading an acrylic binder with a highly reflective, non-optically absorbent pigment material such as TiO₂ or BaSO₄. On the other hand, the depressions known as reflective grooves are formed by method that involves transference from the original in the same manner as the prisms of the prism sheet. The method for producing the original can be realized by a machine processing method using a tool bit, applying an electron beam resist over the substrate then scooping with RIE after drawing with the electron beam, a method involving exposure and development using x-ray light irradiation, or exposure and development of a gray scale mask pattern. The method of transference of a prism form from the original to the material used for forming the prism can involve an extrusion forming method, injection molding, thermal transference or a UV light transference method. For the present invention this is primarily performed by providing reflective grooves.

It is suitable to form a hologram diffusion pattern as an integrated body on the outgoing surface of the light guide 3. This hologram diffusion pattern provides the function of making the luminance distribution in the light emitted from the light guide 3 uniform.

The reflective sheet 7 provided in the light guide 3, operates to raise the efficiency of usage of light from the light source 4 by reflecting that light which passes without being reflected by the reflective dots or reflective grooves back into the light guide 3 again. This reflective sheet 7 is provided by forming a film having a reflective function either by spattering or steam adhesion onto one surface of a base material formed of polyester resin, acrylic resin, polycarbonate resin, polyvinyl chloride resin, polymethacrylimide resin or the light. The film having a reflective function can be provided for example by silver or aluminium. The reflective sheet can be produced by foaming a highly light transmissive resin such as polyester resin, acrylic resin, polycarbonate resin, polyvinyl chloride resin, polymethacrylimide resin, polyethylene resin, polypropylene resin, ethylene-vinyl acetate resin, polystyrene resin, or ring-opening metathesis polymer hydride of norbornene monomer. It is also possible to use an ultrafine foam. Here, the bubbles have an average diameter of not less than 10 μm in each independently formed bubble.

The light source 4 can be configured by providing either a single or a plurality of light emitting diodes (LED), or by providing a type of fluorescent tube having a diameter of a few millimeters, known as a cold cathode tube.

The input part 5 to the light guide operates to eliminate unevenness in the light from the light source 4, and is configured to provide a light diffusion function between the light source 4 and the incident surface of the light guide 3. Basically, the input part 5 is provided by disposing dots or arranging a prism opposing the incident surface of the light guide 3.

The reflective function body 6 encompassing the rear of the light source is formed of the same material as the reflective sheet 7, that is to say, this is provided by disposing at the rear surface of the light source 4 so as to encompass the light source 4, a film having a reflective function, either by spattering or steam adhesion onto one surface of a base material formed of polyester resin, acrylic resin, polycarbonate resin, polyvinyl chloride resin, polymethacrylimide resin or the like, or by disposing at that rear surface of the light source 4 so as to encompass that light source, a body formed by foaming a highly light transmissive resin such as polyester resin, acrylic resin, polycarbonate resin, polyvinyl chloride resin, polymethacrylimide resin, polyethylene resin, polypropylene resin, ethylene-vinyl acetate resin, polystyrene resin, or ring-opening metathesis polymer hydride of norbornene monomer. In this way, light output from the light source 4 that travels in the direction of the rear surface of the light source 4 is directed into the light guide 3 by the operation of the reflective function body 6 thereby enabling more efficient usage of light emitted from the light source 4.

### EMBODIMENTS

A description of the preferred embodiments of the present invention will now be provided, it being understood that the following embodiments are illustrative and not restrictive.

### Embodiment 1

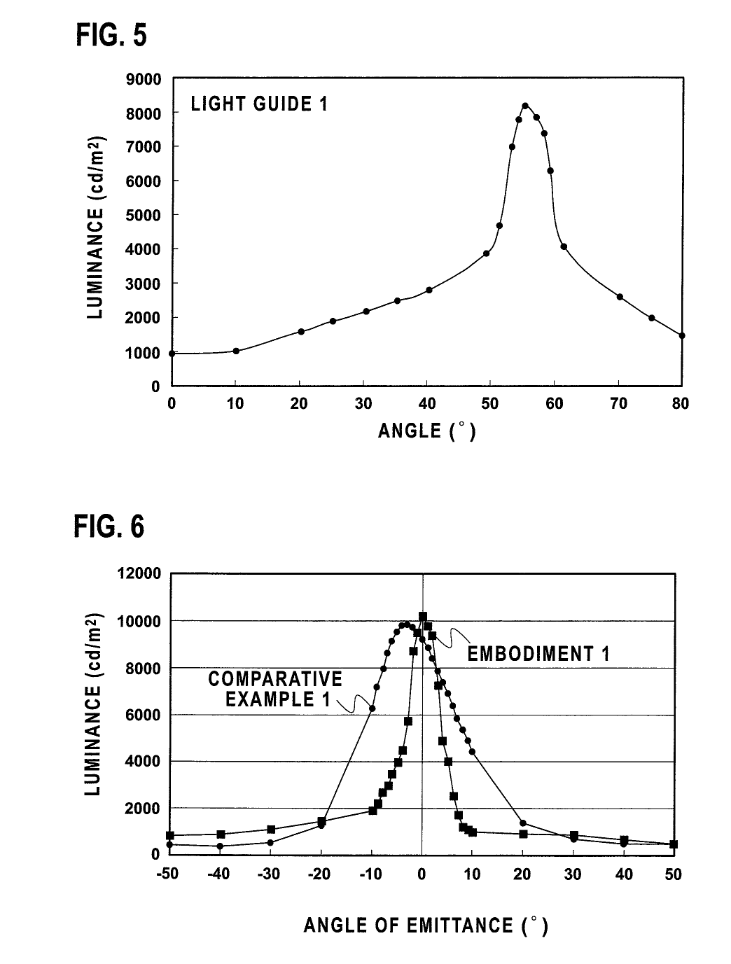

A surface light source device as shown in FIG. 3 was assembled, comprising a light source, light guide and two prism sheets, and the optical characteristics of this device were measured. The light source was provided by four LEDs (NSCW215 by Nichia Corporation). At the rear surface of the light source a polyester resin film of a thickness of 0.025 mm having a silver deposition (of a thickness of 1000 Å applied over the surface thereof, was arranged as a rounded body with a radius of curvature of 1.5 mm. The light guide 1 having the emittance characteristics described in FIG. 5 (half width of 10° at peak angle of emittance 55°) was used for the light guide. Note that a hologram diffusion pattern (diffusion angle 3°) was formed on the outgoing surface side. On the side opposite to the outgoing surface of the light guide a reflective sheet was disposed, having a silver deposition (of a thickness of 1000 Å applied over the surface on one side of a polyester resin film of a thickness of 0.05 mm. A first prism sheet was arranged on the outgoing surface side of the light guide while a second prism sheet was arranged on the outgoing surface side of the first prism sheet. Both the first prism sheet and the second prism sheet were formed of polycarbonate (refractive index of which is 1.58) of a thickness of 150 μm. The pitch of the prism of the first prism sheet was 25 μm, θF₁ was 30° and θB₁, 30°. For the prism of the second prism sheet, the pitch was 25 μm, θF₁ was 5° and θB₁, 72°. These prism sheets were produced using a thermal press. A polycarbonate sheet was set over a die and pressure was then applied from above using a press die. At this time, the temperature of the die was 160° C., the pressure 90 MPa, and this was applied for 8 seconds. The results of measurements taken of the luminance provided by the surface light source device assembled in this manner are shown in FIG. 6. The luminance measurements were taken using a three-dimensional goniophotometer made by Highland. The light source was flashed at a drive current of 18 mA. A comparative example is shown subsequently and the results of the measurements of luminance of this comparative example are arranged side-by-side. Hereafter, the comparisons to the embodiments are all based on comparative example 1.

### Comparative Example 1

The light guide for this example was provided using light guide 4 having the light emission characteristics shown in FIG. 12 (half width 20° at peak emission angle 70°). A hologram diffusion pattern (diffusion angle 3°) was formed on the outgoing surface side. The prism pitch was 30 μm at the outgoing surface side of the light guide and a single prism sheet having an isosceles triangle shaped prism with an apex angle of 60° was disposed such that the prism surface was facing toward the outgoing surface side of the light guide.

### Embodiment 2

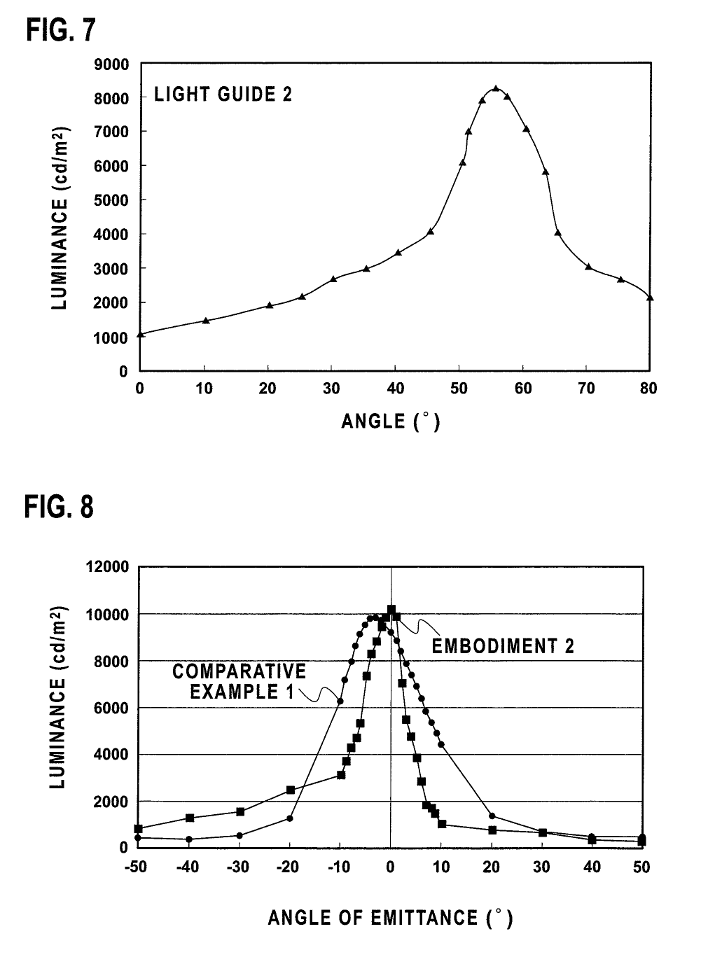

The light guide for this embodiment was provided using light guide 2 having the light emission characteristics (half width 20° at peak emission angle 55°) shown in FIG. 7. A hologram diffusion pattern (diffusion angle 3°) was formed on the outgoing surface side. A first prism sheet was arranged on the outgoing surface side of the light guide, and a second prism sheet was arranged on the outgoing surface side of the first prism sheet. Both the first prism sheet and the second prism sheet were made of polycarbonate (the refractive index of which was 1.58), of a thickness of 150 μm. The pitch of the prism of the first prism sheet was 25 μm, θF₁ was 30°, and θB₁, 30°. The pitch of the prism of the second prism sheet was 25 μm, θF₁ was 5° and θB₁, 72°. FIG. 8 shows the results of luminance measurements for embodiment 2 of the surface light source device according to the present invention and comparative example 1.

### Embodiment 3

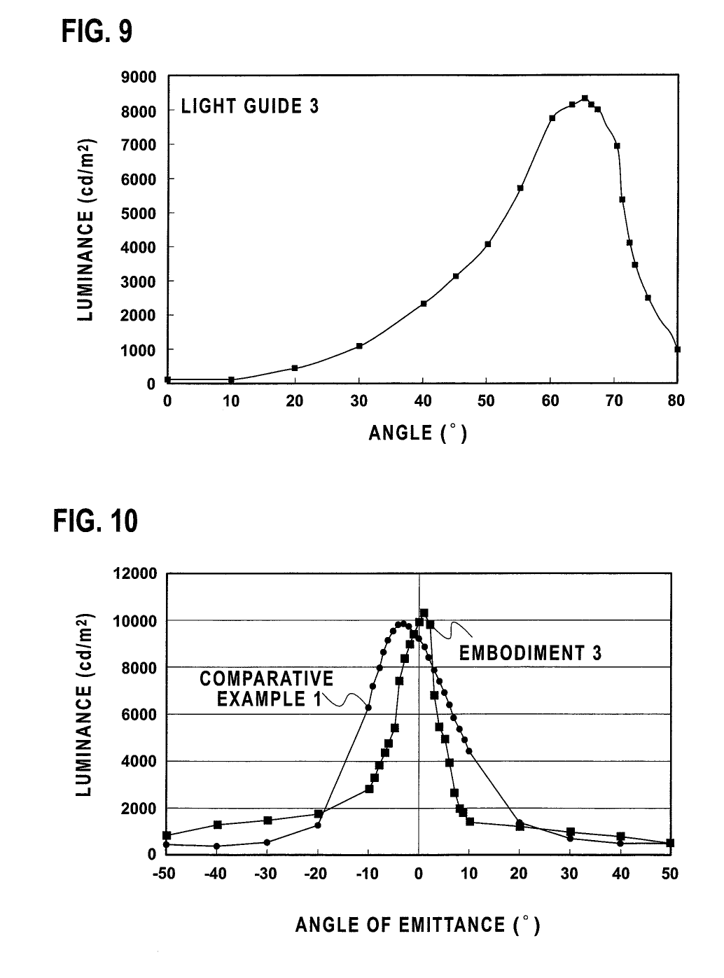

The light guide for this embodiment was provided using light guide 3 having the light emission characteristics (half width 20° at peak emission angle 65°) shown in FIG. 9. A hologram diffusion pattern (diffusion angle 3°) was formed on the outgoing surface side. A first prism sheet was arranged on the outgoing surface side of the light guide while a second prism sheet was arranged on the outgoing surface side of the first prism sheet. Both the first prism sheet and the second prism sheet were made of polycarbonate (refractive index 1.58) having a thickness of 150 μm. The pitch of the prism of the first prism sheet was 25 μm, θF₁ was 30°, and θB₁, 30°. The pitch of the prism of the second prism sheet was 25 μm, θF₁ was 5° and θB₁, 72°. FIG. 10 shows the results of luminance measurements for embodiment 3 of the surface light source device according to the present invention and comparative example 1.

### Embodiment 4

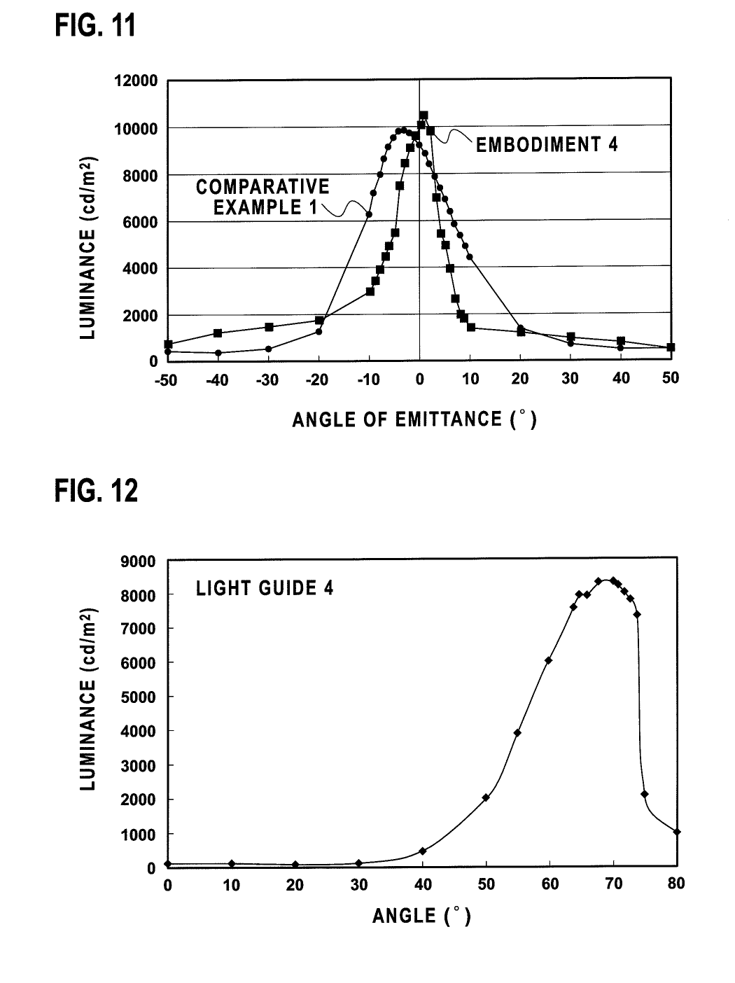

The light guide for this embodiment was provided using light guide 3 having the light emission characteristics (half width 20° at peak emission angle 65°) shown in FIG. 9. A hologram diffusion pattern (diffusion angle 3°) was formed on the outgoing surface side. A first prism sheet was arranged on the outgoing surface side of the light guide while a second prism sheet was arranged on the outgoing surface side of the first prism sheet. Both the first prism sheet and the second prism sheet were made of polycarbonate (refractive index 1.58) having a thickness of 150 μm. The pitch of the prism of the first prism sheet was 30 μm, θF₁ was 30°, and θB₁, 30°. The pitch of the prism of the second prism sheet was 30 μm, θF₁ was 5° and θB₁, 60°. FIG. 11 shows the results of luminance measurements for embodiment 4 of the surface light source device according to the present invention and comparative example 1.

### Embodiment 5

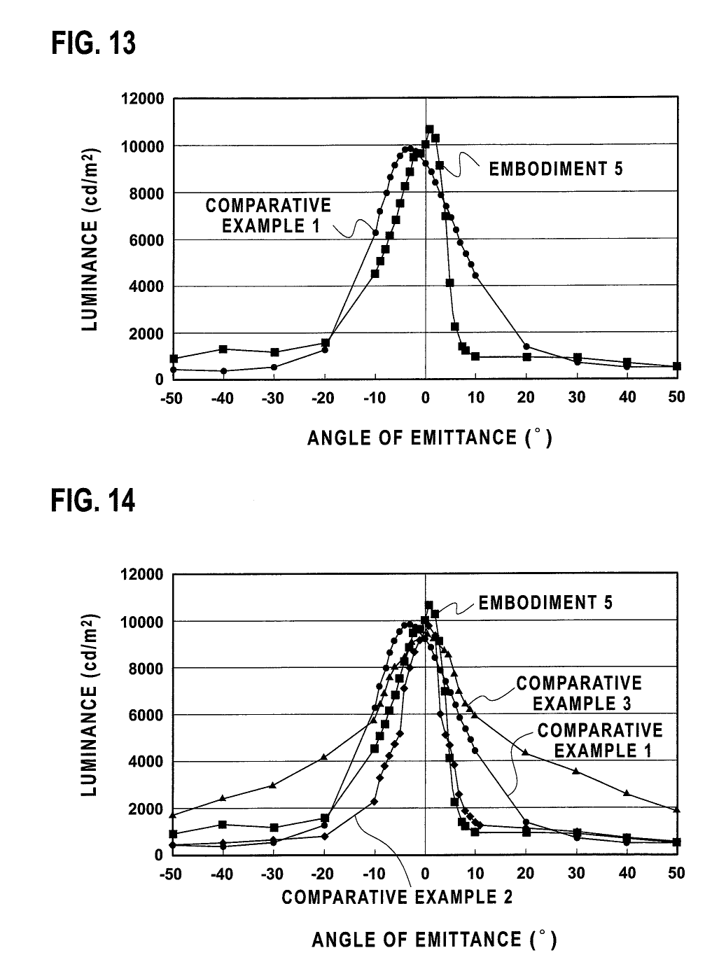

The light guide for this embodiment was provided using light guide 4 having the light emission characteristics (half width 20° at peak emission angle 70°) shown in FIG. 12. A hologram diffusion pattern (diffusion angle 3°) was formed on the outgoing surface side. A first prism sheet was arranged on the outgoing surface side of the light guide while a second prism sheet was arranged on the outgoing surface side of the first prism sheet. Both the first prism sheet and the second prism sheet were made of polycarbonate (refractive index 1.58) having a thickness of 150 μm. The pitch of the prism of the first prism sheet was 30 μm, θF₁ was 30°, and θB₁, 60°. The pitch of the prism of the second prism sheet was 30 μm, θF₁ was 15° and θB₁, 35°. FIG. 13 shows the results of luminance measurements for embodiment 4 of the surface light source device according to the present invention and comparative example 1.

### Comparative Example 2

The light guide for this example was provided using light guide 4 having the light emission characteristics shown in FIG. 12 (half width 20° at peak emission angle 70°). A hologram diffusion pattern (diffusion angle 3°) was formed on the outgoing surface side. A first prism sheet was arranged on the outgoing surface of the light guide while a second prism sheet was arranged on the outgoing surface of the first prism sheet. Both the first prism sheet and second prism sheet were made of polycarbonate (refractive index 1.58) having a thickness of 150 μm. The pitch of the prism of the first prism sheet was 30 μm, θF₁ was 40°, and θB₁, 45°. The pitch of the prism of the second prism sheet was 30 μm, θF₁ was 20° and θB₁, 45°. FIG. 14 shows the results of luminance measurements for comparative example 2.

### Comparative Example 3

The light guide for this example was provided using light guide 4 having the light emission characteristics shown in FIG. 12 (half width 20° at peak emission angle 70°). A hologram diffusion pattern (diffusion angle 3°) was formed on the outgoing surface side. A first prism sheet only, was arranged on the outgoing surface of the light guide. The first prism sheet was made of polycarbonate (refractive index 1.58) having a thickness of 150 μm. The pitch of the prism of the first prism sheet was 30 μm, θF₁ was 34°, and θB₁, 20°. FIG. 14 shows the results of luminance measurements for comparative example 3 also.

The specifications for the surface light source devices of the comparative examples and the embodiments of the present invention and the results of the luminance measurements of these devices are contained in Table 1.

TABLE 1

| | | | | | | | | COM- | COM- |
|---|---|---|---|---|---|---|---|---|---|
| | | | | | | | COMPARATIVE | PARATIVE | PARATIVE |
| | | EMBOD- | EMBOD- | EMBOD- | EMBOD- | EMBOD- | EXAMPLE | EXAMPLE | EXAMPLE |
| ITEM | | IMENT 1 | IMENT 2 | IMENT 3 | IMENT 4 | IMENT 5 | 1 | 2 | 3 |
| LIGHT GUIDE | | 55° | 55° | 65° | 65° | 70° | 70° | 70° | 70° |
| PEAK | | | | | | | | | |
| LIGHT GUIDE | | 10° | 20° | 20° | 20° | 20° | 20° | 20° | 20° |
| HALF WIDTH | | | | | | | | | |
| FIRST PRISM | PITCH | 25 μm | 25 μm | 25 μm | 30 μm | 30 μm | 30 μm | 30 μm | 30 μm |
| | θF₁ | 30° | 30° | 30° | 30° | 30° | DOWNWARD FACING | 40° | 34° |
| | θB₁ | 30° | 30° | 30° | 30° | 60° | PRISM APEX | 45° | 20° |
| | REFRACTIVE | 1.58 | 1.58 | 1.58 | 1.58 | 1.58 | ANGLE 68° | 1.58 | 1.59 |
| | INDEX | | | | | | ISOSCELES | | |
| | | | | | | | TRIANGLE | | |
| SECOND PRISM | PITCH | 25 μm | 25 μm | 25 μm | 30 μm | 30 μm | | 30 μm | — |
| | θF₂ | 5° | 5° | 5° | 5° | 16° | | 20° | — |
| | θB₂ | 72° | 72° | 60° | 60° | 35° | | 45° | — |
| | REFRACTIVE | 1.58 | 1.58 | 1.58 | 1.58 | 1.58 | | 1.58 | — |
| | INDEX | | | | | | | | |

| | | | | | | | | |
|---|---|---|---|---|---|---|---|---|
| PEAK LUMINANCE | 10200 | 10250 | 10350 | 10500 | 10672 | 9823 | 9750 | 9370 |
| (cd/m²) RATIO IN | 104% | 104% | 105% | 107% | 109% | 100% | 99% | 95% |
| RELATION TO | | | | | | | | |
| COMPARATIVE | | | | | | | | |
| EXAMPLE 1 | | | | | | | | |
| PEAK EMITTANCE | 0° | 0° | 1° | 1° | 1° | −3° | 1° | 0° |
| ANGLE | | | | | | | | |
| FRONT SURFACE | 10200 | 10250 | 9900 | 10100 | 9994 | 9209 | 9200 | 9370 |
| LUMINANCE (cd/m²) | 111% | 111% | 108% | 110% | 109% | 100% | 100% | 102% |
| IN RELATION TO | | | | | | | | |
| COMPARATIVE | | | | | | | | |
| EXAMPLE 1 | | | | | | | | |
| HALF WIDTH | 7° | 10° | 10° | 10° | 11° | 10° | 11° | 12° |
| φ₂ | 31.2 | 31.2 | 35.0 | 35.0 | 36.5 | — | 36.5 | 38.2 |
| 90-φ₂-φ_{c1} | 22.5 | 22.5 | 18.7 | 18.7 | 17.2 | — | 17.2 | 17.7 |
| (1) θF₁ ≦ φ₂ | 1.2 | 1.2 | 5.0 | 5.0 | 6.5 | — | −3.5 | 2.2 |
| (2) 90-φ₂-φ_{c1} ≦ θB₁ | 7.5 | 7.5 | 11.3 | 11.3 | 42.8 | — | 27.8 | — |
| φ₆ | 6.6 | 6.6 | 11.3 | 11.3 | 24.2 | — | 18.5 | — |
| 90-φ₅-φ_{c2} | 47.1 | 47.1 | 42.4 | 42.4 | 29.6 | — | 35.2 | — |
| (3) θF₂ ≦ φ₆ | 1.6 | 1.6 | 6.3 | 6.3 | 9.2 | — | −1.5 | — |
| (4) 90-φ₆-φ_{c2} ≦ θB₂ | 24.9 | 24.9 | 17.6 | 17.6 | 5.4 | — | 9.8 | — |

The surface light source device according to the present invention changes, in stages, the inclination of light emitted from a light source that passes a light guide, using at least two prism sheets, while eliminating light loss, such that the light is emitted in the frontal direction to the surface light source device thereby providing a surface light source device that produces greater luminance intensity in the frontal direction in comparison to a conventional surface light source device.

The surface light source device according to the present invention brings a broader range in the distribution of angles of emission of light emitted from the light guide, thereby enabling the proportion of light that can be used for increasing luminance in the frontal direction to be maintained, moreover, as the form of the prisms of the at least two prism sheets satisfy the conditions for determining a specific form, the inclination of the light is changed in stages, while eliminating light loss, enabling light to be emitted in the frontal direction of the surface light source device. The result is that a surface light source is provided in which luminance in the frontal direction is stronger in comparison to surface light source devices of the conventional art and which furnishes superior light condensation properties.

In the surface light source device according to the present invention light emitted from a light guide is enabled to easily reach an oblique side 11a due to refraction at a first prism sheet, moreover, the prism form of the at least two prism sheets satisfies the conditions for determining prism form disclosed in claim 1, thus a surface light source is provided that furnishes superior light condensation properties and in which luminance in the frontal direction is stronger in comparison to surface light source devices of the conventional art.

In the surface light source device according to the present invention light dispersion through diffraction or the like does not occur easily, and as the form of the prisms of the at least two prism sheets satisfies the conditions for determining the prism form disclosed in claim 1, the inclination of light is changed in stages, while eliminating light loss, and light is emitted in the frontal direction of the surface light source device, thereby providing a surface light source device in which light has greater luminance in the frontal direction in comparison to a conventional surface light source device.

1. A surface light source device comprising:
a light source, a light guide having at least one of the side surfaces thereof as an incident surface and an outgoing surface substantially perpendicular to the incident surface, and a prism sheet,
the surface on the side opposing the surface formed by the prism of the prism sheet is arranged so as to be substantially parallel to the outgoing surface of the light guide, and the prism is arranged so as to be substantially parallel to the incident surface of the light guide, wherein
within a cross-section of the prism of the prism sheet substantially perpendicular to both the outgoing surface and the incident surface of the light guide, the angle θF₁ formed between the oblique side of the light source side and the normal to the outgoing surface of the light guide satisfies expression (1), while the angle θB₁ formed between the oblique side on the opposite side to the light source and the normal to the outgoing surface of the light guide satisfies expression (2), wherein
θF₁≦φ₂ (1)
and
90°−φ₂−φ_{c1}≦θB₁ (2),
where in expression (1), φ₂=sin⁻¹ (n₁⁻¹ sin φ₁), n₁ is the refractive index of the material of which the prism of the prism sheet is formed, and φ₁ represents the angle formed between the peak light of the light emitted from the light guide and the normal to the outgoing surface of the light guide, and in expression (2), φ_{c1}=sin⁻¹ (n₁⁻¹) represents the critical angle of the prism sheet.

2. The surface light source device according to claim 1 wherein the angle θF₁ satisfies expression (1a) and that the angle θB₁ satisfies expression (2a), wherein
θF₁≦φ₂−δ₁ (1a)
and
90°−φ₂−φ_{c1}+δ₂≦θB₁ (2a),
where in expression (1a), δ₁ represents the value of half of the half width of the light emitted from the light guide, and in expression (2a), δ₂ represents the value of half of the half width of the light refracted in the prism sheet so that peak light of the light emitted from the light guide enters the prism sheet at an angle φ₁ to the normal of the outgoing surface of the light guide and in the same way peak light of light emitted from the angle formed with the normal to the outgoing surface of the light guide is refracted in the prism sheet at the angle φ₂ to the normal of the outgoing surface of the light guide.

3. The surface light source device according to claim 1 wherein the angle θF₁ satisfies expression (1b), and that the angle θB₁ satisfies the expression (2b), wherein
θF₁≦φ₂−δ₁×2 (1b)
and
90°−φ₂−φ_{c1}+δ₂×2≦θB₁ (2b).

4. The surface light source device according to claim 1 wherein inside the above cross-section, the half width of the emitted light distribution from the light guide is not greater than 30°.

5. The surface light source device according to claim 1 wherein inside the above cross-section, the half width of the emitted light distribution from the light guide is not less than 15° and not greater than 30°.

6. The surface light source device according to claim 1 wherein inside the above cross-section, the peak outgoing angle of emitted light distribution of the light guide is not less than 60°.

7. The surface light source device according to Claim 1 wherein the prism pitch is not less than 30 μm.

8. The prism sheet used in the surface light source device according to claim 1.

9. A surface light source device comprising:
a light source, a light guide having at least one of the side surfaces thereof as an incident surface and an outgoing surface substantially perpendicular to the incident surface, and at least two prism sheets,
the surfaces formed by the prisms of the prism sheets are arranged at the same orientation, the surfaces of the sides opposing the surfaces formed by the prisms of the prism sheets are arranged substantially parallel to the outgoing surface of the light guide, and the prisms are arranged so as to be substantially parallel to the incident surface of the light guide, wherein
within a cross-section of the prism of the first prism sheet substantially perpendicular to both the outgoing surface and the incident surface of the light guide, the angle θF₁ formed between the oblique side of the light source side and the normal to the outgoing surface of the light guide satisfies expression (1), the angle θB₁ between the oblique side of the opposite side to the light source and the normal to the outgoing surface of the light source satisfies expression (2),
within a cross-section of the prism of the i-th prism sheet (where i is an integer not less than 2) arranged on the outgoing surface of the first prism sheet substantially perpendicular to both the outgoing surface and the incident surface of the light guide, the angle θFᵢ between the oblique side of the light source side and the normal to the outgoing surface of the light guide satisfies expression (3) and the angle θBᵢ between the oblique side of the opposite side to the light source and the normal to the outgoing surface of the light source satisfies expression (4), wherein
δF₁≦φ₂ (1),
90°−φ₂−φ_{c1}≦θB₁ (2),
θFᵢ≦φ₆ (3)
and
90°−φ₆−φ_{ci}≦θBᵢ (4),
where in expression (1), φ₂=sin⁻¹ (n₁⁻¹ sin φ₁), n₁ is the refractive index of the material of which the prism of the first prism sheet is formed, φ₁=sin⁻¹ (n₁⁻¹) represents the angle formed between the peak light of light emitted from the light guide and the normal to the outgoing surface of the light guide, in expression (2), φ_{c1} represents the critical angle of the first prism sheet, in expression (3), φ₆=sin⁻¹ (nᵢ⁻¹ sin φ₅), nᵢ is the refractive index of the material of which the prism of the i-th prism sheet is formed, and φ₅ is the angle formed between the normal to the outgoing surface of the light guide and the peak light of light emitted from the i−1 prism sheets, and in expression (4), φ_{ci}=sin⁻¹ (nᵢ⁻¹) represents the critical angle of the i-th prism sheets.

10. The surface light source device according to claim 9 wherein the angles θF₁, θB₁, θFᵢ and θBᵢ satisfy the following expressions (1a), (2a), (3a) and (4a), respectively, wherein
θF₁≦φ₂−δ₁ (1a),
90°φ₂−φ_{c1}+δ₂≦θB₁ (2a),
θFᵢ≦φ₆−δ₃ (3a)
and
90°−φ₆−φ_{ci}+δ₄≦θBᵢ (4a),
where in expression (1a), δ₁ represents the value of half the half width of light emitted from the light guide, in expression (2a), δ₂ represents the value of half of the half width of the light refracted in the prism sheet so that peak light of the light emitted from the light guide enters the prism sheet at an angle φ₁ to the normal of the outgoing surface of the light guide and in the same way peak light of light emitted from the angle formed with the normal to the outgoing surface of the light guide is refracted in the prism sheet at the angle φ₂ to the normal of the outgoing surface of the light guide, in expression (3a), δ₃ represents the value of half the half width of light emitted from the i−1 prism sheets, and in expression (4a), δ₄ represents that peak light of light emitted from the i−1st prism sheets is input to the i-th prism sheet at the angle φ₅ to the normal of the outgoing surface of the light guide and in the same way peak light of light emitted from the angle formed with the normal to the outgoing surface of the light guide is refracted in the i-th prism sheet at the angle φ₆ to the normal of the outgoing surface of the light guide.

11. The surface light source device according to claim 9 wherein the angles θF₁, θB₁, θFᵢ and θBᵢ satisfy the following expressions (1b), (2b), (3b) and (4b), respectively, wherein
θF₁≦φ₂−δ₁×2 (1b),
90°−φ₂−φ_{c1}+δ₂×2≦θB₁ (2b),
θFᵢ≦φ₆−δ₃×2 (3b)
and
90°−φ₆−φ_{ci}+δ₄×2≦θBᵢ (4b).

12. The surface light source device according to claim 9 wherein inside the cross-section, the half width of the emitted light distribution of the light guide is not greater than 30°.

13. The surface light source device according to claim 9 wherein inside the cross-section, the half width of the emitted light distribution of the light guide is not less than 15° and not greater than 30°.

14. The surface light source device according to claim 9 wherein inside the cross-section, the angle of emittance at which emitted light distribution of the light guide peaks is not less than 60°.

15. The surface light source device according to claim 9 wherein the pitch of the prism is not less than 30 μm.

16. The prism sheet used in the surface light source device according to claim 9.
